(19) United States
(12) Patent Application Publication
(10) Pub. No.: US 2010/0293379 A1
(43) Pub. Date: Nov. 18, 2010

(54) METHOD FOR SECURE DATA TRANSMISSION IN WIRELESS SENSOR NETWORK

(75) Inventor: Xin Nie, Beijing (CN)

Correspondence Address: TUROCY & WATSON, LLP, 127 Public Square, 57th Floor, Key Tower, CLEVELAND, OH, 44114, US

(73) Assignee: Beijing Transpacific IP Technology Development Ltd, Beijing (CN)

(21) Appl. No.: 12/601,987

(22) PCT Filed: May 26, 2008
(86) PCT No.: PCT/CN2008/701089

§ 371 Date: Jun. 3, 2010

(30) Foreign Application Priority Data
May 31, 2007 (CN) 200710099880.2

(51) Int. Cl. H04W 12/06; H04W 12/04; H04L 9/08

(52) U.S. Cl. 713/169; 380/270; 380/45; 380/281

(57) ABSTRACT

A method for secure data transmission in wireless sensor network includes that: the network user determines a master key and inputs it into a central node and a device node; after the central node and the device node have authorized each other, the central node generates a new session key and sends it to the device node; while the central node and the device node communicate with each other, the data sending party uses the new session key to encrypt the data for transmission and verify the integrity of the data, and the data receiving party uses the session key to decrypt the data and verify the integrity of the data. The advantages of the present invention are that: the consumption of computation resource and the communication overhead are greatly reduced without affecting the security performance of the network, the problem of the authorization between the central node and the device node is solved, and the method for generating, transmitting and updating the key realizes the encryption of the data for transmission and the verification of the data integrity, and thus it ensures the security of the data transmission in wireless sensor network.

### BACKGROUND OF THE INVENTION

1. Field of the Invention

The present invention relates to a method for secure data transmission in wireless sensor network, and belongs to the wireless communication technology field.

2. Description of the Prior Art

The wireless sensor network is a kind of the wireless communication system, and its basic unit is node. A node uses wireless transmitters/receivers to transmit the data through wireless channels. There are two types of nodes in the wireless sensor network: central node and device node.

A typical device node comprises a data pickup unit, a data processing unit, a data transmission unit and a power supply. The data pickup unit is usually a sensor, and its type is determined by physical form of the monitored signal. The data pickup unit collects information from its surroundings, and transmits the information to the central node via the data transmission unit under control of the data processing unit.

The central node is an interface interconnecting the wireless sensor network and other external communication system such as the internet. The central node transmits the data collected by the device nodes to the remote users via the internet, and likewise, the user can transmit control instructions to the central node via the internet. The central node forwards the instruction to the device node for the user to control the network. Compared to the device node, the central node generally has stronger computation ability and more system resources.

The wireless sensor network is widely used in environmental surveillance, space exploration, emergency service & disaster relief, smart home, etc. However, the node in the wireless sensor network usually has following characteristics: limited energy, limited computation ability and limited storage capacity. Firstly, energy is the main factor that limits the ability and duration of the node. A conventional sensor node generally uses batteries to provide the electricity, and cannot be recharged. Secondly, CPU of the node in the sensor network has only 8 bit and 4˜8 MHz capabilities. Moreover, the storage capacity of the node is also limited. Unlike the cable network using wire transmission from node to node, the wireless sensor network transmits signals by wirelessly broadcasting. Because of the openness of the wireless transmission medium, all nodes within the signal coverage can receive the signals, so the transmitted data is vulnerable to various security threats such as eavesdropping, data manipulation, and data replaying. Thus, it is crucial to adopt some methods to protect the security of the data transmission in the wireless sensor network, and the methods are generally related to authorization, encryption, and data integrity verification.

Authorization is a process of two nodes confirming the legal identification of each other, usually related to data interexchange between two nodes for verifying the legitimacy of each other. Only upon a successful authorization process, a trusted relationship between the two nodes can be established that allows a secured data communication to be initialized.

Encryption is a process of converting the data from plaintext into unrecognized ciphertext. Decryption is a process of converting ciphertext into plaintext. An encryption system generally comprises four parts: plaintext, the data to be encrypted; ciphertext, the data encrypted from the plaintext; an encryption algorithm; key, a string or digital series with specific length used together with the encryption algorithm for controlling the encryption and the decryption. While a sender transmits the ciphertext to a receiver via a transmission medium, the ciphertext may be intercepted or eavesdropped by a third party. Nevertheless, as long as the third party does not have the key, the ciphertext is just some meaningless codes that don't reveal any information. Therefore, the data transmission can be secured.

The integrity of data is verified to prevent the third party from either knowing or manipulating the data content to ensure the security of data transmission. Usually a one-way Hash function is used to verify the data integrity. To verify the data integrity, an ‘abstract’ with a fixed length has to be generated according to the plaintext to be verified, and the ‘abstract’ is referred to as message authentication code (MAC). Different MACs are definitely generated from Different plaintext, while MACs generated from the same plaintext would always be identical. Thus, it can be determined whether data is manipulated during the transmission according to the MAC. In the wireless sensor network, the MAC is usually generated by the one-way Hash function and attached to the data to be transmitted. After receiving the data, the data receiving party calculates the MAC and compares the MAC with the attached MAC. If the comparison is matched, the data is deemed integral; otherwise, it is deemed manipulated.

Due to the aforementioned characteristics of the wireless sensor network, the conventional security method has hit some bottlenecks when adapted in the wireless sensor network. Firstly, the consumption of computation resource is large, while the computation resource and ability in the node are limited, thus the security method that consumes significant computation resource is inadequate for the wireless sensor network. Secondly, in the conventional security method, significant amount of data exchange is required, inducing additional network communication and energy consumption that degrades the performance of network, so the conventional security method is also infeasible for the wireless sensor network. If the conventional security method is applied, the node may be overloaded with the security computation tasks while the performance of other tasks is affected. Thirdly, the excessive computation and the communication increase the power consumption of the node, so the energy of the node may be rapidly drained out and consequently the efficiency of the network is reduced. Restricted by the above disadvantages, the conventional security method is infeasible for the wireless sensor network, and the authorization between nodes remains as an unsolved issue.

### SUMMARY OF THE INVENTION

An exemplary embodiment of the invention provides a method for secure data transmission in the wireless sensor network to work around with the difficulties caused by significant consumption of computation resource and the large overhead of the protocol communication in the conventional security method and to provide an authorization mechanism between the nodes, and further to secure data transmissions in the wireless sensor network with limited node resources.

The method for secure data transmission in the wireless sensor network includes following steps.

(1) The user of the wireless sensor network acquires a master key of a device node after purchasing the device node, and inputs the master key into a center node of the wireless sensor network;

(2) The central node and the device node performs authorizations on each other to verify mutual legitimacies;

(3) The central node periodically performs a Hash function using the master key and a random number to generate a session key;

(4) The central node generates a message authentication code (MAC) for the session key, encrypts the session key with the MAC using the master key to generate an encrypted session key, and sends the encrypted session key to the device node communicating with the central node;

(5) Upon reception of the encrypted session key, the device node decrypts and verifies the encrypted session key with the MAC using the master key, and replaces a previous session key used by the device node by the session key;

(6) The device node generates a MAC for a first data package to be transmitted, encrypts the first data package with the MAC into an encrypted first package using the session key, and then transmits the encrypted first data package to the central node; the central node decrypts the encrypted first data package and verifies the MAC to confirm integrity of the first data package; and

(7) The central node uses the session key generated in step (3) to encrypt a second data package to be transmitted with a MAC of the second data package, and sends the encrypted second data package to the device node communicating with the central node; the device node decrypts the encrypted second data package and verifies the MAC to confirm integrity of the second data package.

The authorization between the central node and the device node includes the following steps.

(1) The central node generates a MAC for a first random number, encrypts the first random number with the MAC using the master key, and sends them to the device node communicating with the central node; The device node decrypts the first random number and the MAC thereof, verifies the MAC of the first random number to obtain the first random number.

(2) The device node generates a MAC for a second random number, encrypts the second random number with the MAC using the master key, and sends them to the central node; the central node decrypts and verifies the encrypted second number with the MAC to confirm safe reception of the second random number.

(3) The central node generates a MAC for a central node identification (ID), encrypts the central node ID with the MAC using the master key, and sends the encrypted central node ID to the device node communicating with the central node; The device node decrypts and verifies the encrypted central node ID with the MAC to confirm safe reception of the central node ID.

(4) The device node generates a MAC for a device node ID, encrypts the device node ID with the MAC using the master key, and sends the encrypted device node ID to the central node; the central node decrypts and verifies the encrypted device node ID with the MAC to confirm safe reception of the device node ID.

(5) The central node generates a MAC for a first parameter S1, encrypts the first parameter S1 with MAC using the master key, and then sends the encrypted first parameter S1 with MAC to the device node, where the first parameter S1 denotes certain information pre-shared by the central node and the device node including the following items sequentially appended one after another: the first data, the center node ID, the device node ID, the first random number and the second random number.

(6) The device node generates a MAC for a second parameter S2, encrypts the second parameter S2 with MAC using to the master key, and sends the encrypted second parameter S2 with MAC to the central node, where the second parameter S2 denotes certain information pre-shared by the central node and the device node, including the following items sequentially appended one after another: the central node ID, the device node ID, the central node ID, the first random number, and the second random number.

(7) The central node decrypts the encrypted second parameter S2 sent from the device node into a decrypted second parameter S2 and a decrypted second MAC, Hashes the decrypted second parameter S2 to generate a second local MAC, and verifies the validity the decrypted second parameter S2 by comparing the second local MAC with the decrypted second MAC. If the comparison is matched, the authorization is deemed as passed. Otherwise the authorization is failed.

(8) The device node decrypts the encrypted first parameter S1 sent from the central node into a decrypted first parameter S1 and a decrypted first MAC, Hashes the decrypted first parameter S1 to generate a first local MAC, and verifies the validity of the decrypted first parameter S1 by comparing the first local MAC with the decrypted first MAC. If the comparison is matched, the authorization is deemed as passed. Otherwise, the authorization is failed.

The method for secure data transmission in wireless sensor network significantly reduces the computation resource consumption and the communication overhead without affecting the security performance of the network, and solves the difficulty of authorization between the nodes of the wireless sensor network. The methods for generating, transmitting, and updating the key are provided, and the data encryption and integrity verification greatly ensure the security of the data transmission in wireless sensor network.

### BRIEF DESCRIPTION OF THE DRAWINGS

FIG. 1 is a flowchart of an embodiment of the data transmission method.

FIG. 2 is a flowchart of an embodiment of authorization between the central node and the device node.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

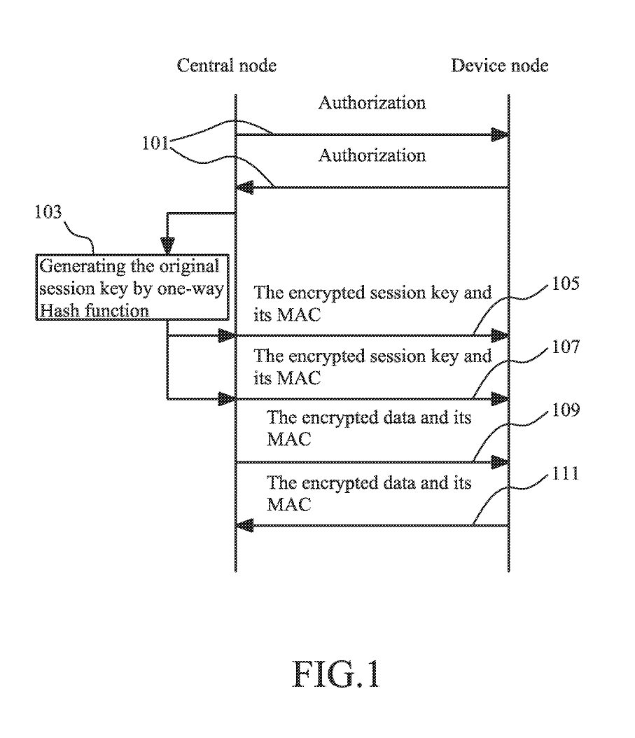

FIG. 1 shows an embodiment of a flowchart of the data transmission method. Firstly, the user of the wireless sensor network acquires a master key of a device node after purchasing the device node, and inputs the master key into a central node of the wireless sensor network. In step 101, the central node and the device node perform authorizations with each other for verifying the legitimacy of both sides. In step 103, the central node periodically performs a Hash function (e.g. one-way Hash function) using the master key and a random number to generate a session key. In step 105, the central node generates a message authentication code (MAC) for the session key, encrypts the session key with the MAC to generate an encrypted session key using the master key, and sends the encrypted session key to the device node communicating with the central node. Upon reception of the encrypted session key, the device node decrypts the encrypted session key into an updated session key and a decrypted MAC using the master key, verifies the decrypted MAC to confirm integrity of the updated session key, and replaces an existing session key used by the device node with the updated session key. In step 109, the central node uses the updated session key to encrypt a first data package to be transmitted with a MAC of the first data package, and sends the encrypted first data package to the device node communicating with the central node; the device node decrypts the encrypted first data package and verifies the MAC to confirm integrity of the first data package. In step 111, upon acquisition of the updated session key, the device node generates a MAC for a second data package to be transmitted, encrypts the second data package with its MAC by the updated session key, and sends the encrypted first data package to the central node; the central node decrypts the encrypted first data package into a decrypted first data package and a decrypted MAC, verifies the decrypted MAC to confirm integrity of the decrypted first data package.

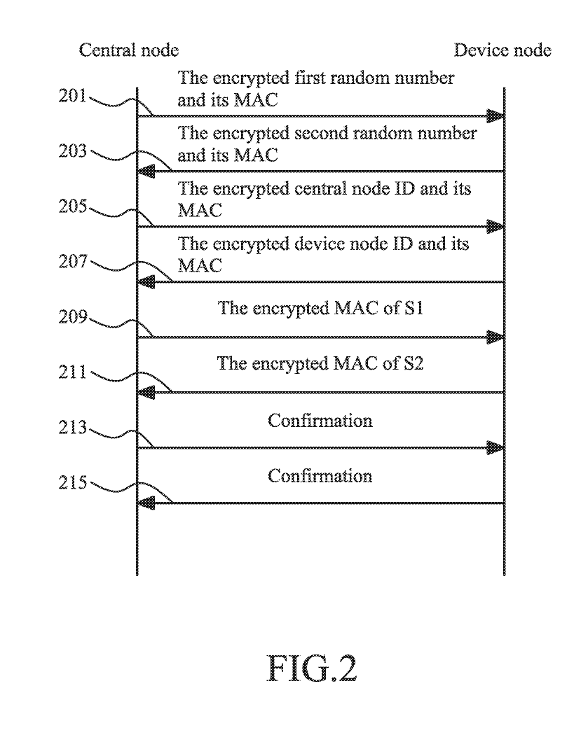

FIG. 2 is a flowchart of an embodiment of authorization between the central node and the device node.

(1) In step 201, the central node generates a MAC for a first random number, encrypts the first random number with the MAC using the master key, and sends them to the device node communicating with the central node; the device node decrypts the first random number and the MAC thereof, verifies the MAC of the first random number and confirms the integrity of the first random number;

(2) In step 203, the device node generates a MAC for a second random number, encrypts the second random number and the MAC thereof using the master key, and sends the encrypted second number and the MAC thereof to the central node; the central node decrypts the second number and the MAC thereof, verifies the MAC of the second random number to confirm integrity of the second random number;

(3) In step 205, the central node generates a MAC for a central node identification (ID), encrypts the central node ID and the MAC thereof using the master key, and sends the encrypted central node ID and the MAC to the device node communicating with the central node; the device node decrypts the central node ID and the MAC, verifies the MAC of the central node ID to confirm integrity of the central node ID;

(4) In step 207, the device node generates a MAC for a device node ID, encrypts the device node ID and the MAC thereof using the master key, and sends the encrypted device node ID and the MAC to the central node; the central node decrypts the device node ID and the MAC, verifies the MAC of the device node ID to confirm integrity of the device node ID;

(5) In step 209, the central node uses the master key to compute a MAC of a first parameter S1, encrypts the MAC and sends it to the device node, where the first parameter S1=a first data pre-shared by the central node and the device node ∥ the central node ID ∥ the device node ID ∥ the first random number ∥ the second random number. The notation “M1 ∥M2”, denotes a relationship that the data M2 is attached behind the data M1.

(6) In step 211, the device node uses the master key to compute a MAC of a second parameter S2, encrypts the MAC and sends it to the central node, where S2=a second data pre-shared by the central node and the device node ∥ the central node ID ∥ the device node ID ∥ the first random number ∥ the second random number.

(7) In step 213, the central node decrypts the encrypted second parameter S2 sent from the device node into a decrypted second parameter S2 and a decrypted MAC, Hashes the decrypted second parameter S2 to generate a local MAC, and verifies the validity the decrypted second parameter S2 by comparing the local MAC with the decrypted MAC. If the comparison is matched, the authorization is deemed as passed; otherwise the authorization is failed.

(8) In step 215, the device node decrypts the encrypted first parameter S1 sent from the central node into a decrypted first parameter S1 and a decrypted first MAC, Hashes the decrypted first parameter S1 to generate a first local MAC, and verifies the validity of the decrypted first parameter S1 by comparing the first local MAC with the decrypted first MAC. If the comparison is matched, the authorization is deemed as passed. Otherwise, the authorization is failed.

The method uses two keys: the master key and the session key. The master key is used to generate, update, and transmit the session key. The session key is used to encrypt the data for transmission and verify the data integrity in the network.

In following text, the present method is described in details with reference to the accompanying drawings, which includes the following steps.

Firstly, the master key is shared by the central node and the device node, and this process is completed by the network user. The user selects a master key, and inputs the master key into the central node and the device node, each device node corresponding to one master key. The central node maintains a sheet for recording IDs of different device nodes corresponding with the master keys and the latest session keys. Thus, the secret value is set between the central node and the device node, and access controlling is realized to prevent unauthorized user accessing the network in the mean time.

Secondly, the central node and the device node are authorized by each other for confirming the legitimacy of both sides, and this process is completed by the central node and the device node automatically, as shown in FIG. 2.

During the authorization, the central node and the device node each generates a random number, respectively called the first random number and the second random number. The first random number and the second random number are usually two strings with the same length to ensure generating different security information in each authorization process, which enhances the security of the authorization. The central node generates the first random number, attaches the MAC behind the first random number, uses the master key to encrypt the first random number and the MAC, and sends the encrypted first random number and MAC to the device node communicating with the central node; the device node encrypts the received data, verifies the MAC of the first random number, and gets the first random number of the central node.

The device node generates the second random number after receiving the first random number sent by the central node, attaches the MAC behind the second random number, uses the master key to encrypt the second random number and the MAC, and transmits the encrypted second random number and MAC to the central node; the central node decrypts the received data, verifies the MAC of the second random number, and gets the second random number of the device node.

Exchange of the random numbers between the central node and the device node in communication is completed as above. After the exchange of the random numbers, the central node and the device node exchange the node ID as follows:

The central node attaches the MAC behind the central node ID, uses the master key to encrypt the central node ID and the MAC, and transmits the encrypted central node ID and the MAC to the device node in communication; the device node decrypts the received data and verifies the MAC of the central node ID to get the central node ID.

After receiving the central node ID transmitted by the central node, the device node attaches the MAC behind the device node ID, uses the master key to encrypt the device node ID and the MAC, and sends the encrypted device node ID and the MAC to the central node; the central node decrypts the received data and verifies the MAC of the device node to get the device node ID. Thus, the ID exchange between the central node and the device node is completed.

After the exchange of the random numbers and the node IDs between the central node and the device node is completed, the central node and the device node both get the first random number, the second random number, and the IDs of the central node and the device node. The central node and the device node respectively compute the first parameter and the second parameter according to the following method, and compute the corresponding MACs of the first parameter and the second parameter.

The central node computes the first parameter, and the first parameter=data 1 shared in advance by the central node and the device node ∥ the central node ID ∥ the device node ID ∥ the first random number ∥ the second random number. The central node uses the master key to compute the MAC of the first parameter, encrypts the MAC, and sends it to the device node.

The device node computes the second parameter, and the second parameter=data 2 shared in advance by the central node and the device node ∥ the central node ID ∥ the device node ID ∥ the first random number ∥ the second random number. The device node uses the master key to compute the MAC of the second parameter, encrypts the MAC, and sends it to the central node.

The central node and the device node generate different random number in each authorization process, so the first parameter and the second parameter which are generated are also different according to the first random number, the second random number and the nodes ID.

The central device node decrypts the received data, gets the MAC of the second parameter, and compares it with the local computed MAC of the second parameter. If the two MACs are same, the device node and the central node have the same key and the device node is legal, and then the central node sends a confirmation to the device node, in which the device node is authorized by the central node; if the two MACs are different, the confirmation sent by the central node shows that the authorization fails.

The device node decrypts the received data, gets the MAC of the second parameter, and compares it with the local computed MAC of the first parameter. If the two MACs are same, the central node and the device node have the same key and the central node is legal, and then the device node sends a confirmation to the central node, in which the central node is authorized by the device node; if the two MACs are different, the confirmation sent by the device node shows that the authorization fails.

If one side confirms the authorization fails, then the authorization fails, and both nodes cannot proceed with data transmission. Only when two sides both confirm the authorization is passed, the central node and the device node can proceed with the data commission.

The session key is generated by the central node. After the central node and the device node are authorized by each other, the central node periodically performs Hash function to generate the session key according to the security information. The security information is composed by the master key corresponding to the device node and the random number with a certain length. The security information is used as the input of the one-way Hash function, and the output of the Hash function is the session key, that is, the session key=H (the master key ∥ random numbers),

Where H is the one-way Hash function, and the symbol “∥” represents that the random numbers are attached behind the master key.

The central node usually has high computation ability and system source, so the session key is generated by the central node, which not only increases the system speed, but also reduces the consumption of computation resource and the power consumption of the device node. After the same session key is used for a period of time, the security of the data encrypted by this session key will decrease, thus the session key used to encrypt data ought to be updated continuously and this problem can be solved by periodically generating and transmitting new session key by the central node.

After the new session key is generated, the central node searches the corresponding master key of the device node according to the device node ID. The central node attaches the MAC behind the new session key, uses the master key to encrypt the session key and the MAC and sends them to the device node. After successfully transmitting the session key to the device node, the central node updates corresponding items in the local sheet for the session key. Using the master key to encrypt the session key ensures the secure transmission of the session key.

After receiving the session key, the device node firstly uses the master key to decrypt the received data and verifies the MAC of the session key to get the new session key, and then replaces the existing session key of the device node with the new session key.

After the central node and the device node complete updating the session keys, the data begins to transmit between nodes in ciphertext. Before transmitting the data to the central node, the device node attaches the MAC behind the data, uses the latest session key to encrypt the data and the MAC thereof, and sends them to the central node. However, before transmitting the data to the device node, the central node firstly finds out the session key corresponding to the device node according to the device node ID, attaches the MAC behind the data for transmission, uses the latest session key to encrypt the data and the MAC thereof, and sends them to the device node.

What is claimed is:

1. A method for secure data transmission in a wireless sensor network, the steps of the method comprising:
(1) inputting a master key of a device node into a center node of the wireless sensor network;
(2) the central node and the device node performing authorizations on each other to verify mutual legitimacies;
(3) the central node periodically performing a Hash function using the master key and a random number to generate a session key;
(4) the central node generating a message authentication code (MAC) for the session key, encrypting the session key with its MAC using the master key to generate an encrypted session key, and sending the encrypted session key to the device node communicating with the central node;
(5) upon reception of the encrypted session key, the device node decrypting and verifying the encrypted session key with its MAC using the master key, and replacing a previous session key used by the device node by the session key;
(6) the device node generating a MAC for a first data package to be transmitted, encrypting the first data package with its MAC into an encrypted first package using the session key, and then transmitting the encrypted first data package to the central node; the central node decrypting the encrypted first data package and verifying the MAC to confirm integrity of the first data package; and
(7) the central node using the session key generated in step (3) to encrypt a second data package to be transmitted with its MAC, and sending the encrypted second data package to the device node communicating with the central node; the device node decrypting the encrypted second data package and verifies its MAC to confirm integrity of the second data package.

2. The method of claim 1, wherein the authorizations performed by the central node and the device node comprise:
(1) the central node generating a MAC for a first random number, encrypting the first random number with the MAC using the master key, and sending them to the device node communicating with the central node; the device node decrypting the first random number and the MAC thereof, verifying the MAC of the first random number to obtain the first random number;
(2) the device node generating a MAC for a second random number, encrypting the second random number with the MAC using the master key, and sending them to the central node; the central node decrypting and verifying the encrypted second number with the MAC to confirm safe reception of the second random number;
(3) the central node generating a MAC for a central node identification (ID), encrypting the central node ID with the MAC using the master key, and sending the encrypted central node ID to the device node communicating with the central node;
the device node decrypting and verifying the encrypted central node ID with the MAC to confirm safe reception of the central node ID;
(4) the device node generating a MAC for a device node ID, encrypting the device node ID with the MAC using the master key, and sending the encrypted device node ID to the central node; the central node decrypting and verifying the encrypted device node ID with the MAC to confirm safe reception of the device node ID;
(5) the central node generating a MAC for a first parameter S1 and encrypting it using the master key, and then sending it to the device node, where the first parameter S1 denotes certain information pre-shared by the central node and the device node including the following items sequentially appended one after another:
the first data, the center node ID, the device node ID, the first random number and the second random number;
(6) the device node generating a MAC of a second parameter S2 and encrypting it using to the master key, and sending it to the central node, where the second parameter S2 denotes certain information pre-shared by the central node and the device node, including the following items sequentially appended one after another: the central node ID, the device node ID, the central node ID, the first random number, and the second random number;
(7) the central node decrypting the encrypted second parameter S2 sent from the device node into a decrypted second parameter S2 and a decrypted MAC, hashing the decrypted second parameter S2 to generate a local MAC, and verifying the validity the decrypted second parameter S2 by comparing the local MAC with the decrypted MAC; wherein if the comparison is matched, the authorization is deemed as passed; otherwise the authorization is failed;
(8) the device node decrypting the encrypted first parameter S1 sent from the central node into a decrypted first parameter S1 and a decrypted first MAC, hashing the decrypted first parameter S1 to generate a first local MAC, and verifying the validity of the decrypted first parameter S1 by comparing the first local MAC with the decrypted first MAC; wherein if the comparison is matched, the authorization is deemed as passed; otherwise the authorization is failed.
